(19) United States
(12) Patent Application Publication
(10) Pub. No.: US 2012/0129476 A1
(43) Pub. Date: May 24, 2012

(54) RADIO SYSTEM INCLUDING TERRESTRIAL AND INTERNET RADIO

(75) Inventors: J. William Whikehart, Milford, MI (US); Shadi Mere, Canton, MI (US); Theodore Charles Wingrove, Canton, MI (US)

(73) Assignee: VISTEON GLOBAL TECHNOLOGIES, INC., Van Buren Twp., MI (US)

(21) Appl. No.: 13/356,913

(22) Filed: Jan. 24, 2012

Related U.S. Application Data
(63) Continuation-in-part of application No. 12/953,897, filed on Nov. 24, 2010.

(51) Int. Cl. H04B 1/18

(52) U.S. Cl. 455/179.1

(57) ABSTRACT

A radio system includes a radio tuner for receiving a terrestrial radio signal, a communication device for receiving an internet data, a user interface in signal communication with at least the radio tuner to provide a selective control of at least the radio tuner, and a processor in signal communication with the radio tuner, the communication device, and the user interface, wherein the processor receives a user preference data from at least one of the communication device and the user interface, analyzes the user preference data based on an instruction set, and selectively transmits an audio output to a user based upon the user preference data, wherein a source of the audio output is one of the terrestrial radio signal and the internet data.

### CROSS-REFERENCE TO RELATED APPLICATION

This application is a continuation-in-part and claims the benefit of U.S. application Ser. No. 12/953,897 filed on Nov. 24, 2010.

### FIELD OF THE INVENTION

The present invention relates generally to a radio system. In particular, the invention is directed to an adaptive radio system having multiple signal sources.

### BACKGROUND OF THE INVENTION

Currently, there are generally four types of radio platforms available in a vehicle environment: terrestrial AM/FM radio, terrestrial HD radio, an all digital radio, a digital audio broadcast, and an Internet radio.

Internet radio has the advantage of allowing a user build a profile of preferred stations. For example, programs such as the Music Genome Project from the Pandora Media company automatically select a similar genre of music for playback based on a preferred band identified by a user.

However, a shortcoming of Internet radio in a moving vehicle is the continuing connectivity with the Internet (i.e. sometimes the Internet radio connection is lost due to poor connectivity).

Current terrestrial radio systems do not automatically create a profile of preferred stations. Although a user may preset certain regional terrestrial radio channels, the user is forced to search for desirable stations when travelling in a region beyond the broadcast range of preset channels.

It would be desirable to develop an adaptive radio system having multiple signal sources, wherein the radio system selectively transmits an audio output from one of the signal sources to a user based upon a preference of the user.

### SUMMARY OF THE INVENTION

Concordant and consistent with the present invention, an adaptive radio system having multiple signal sources, wherein the radio system selectively transmits an audio output from one of the signal sources to a user based upon a preference of the user, has surprisingly been discovered.

The invention provides methods for determining the flow content transmitted audibly to a user. One method comprises the steps of: providing a terrestrial radio tuner for receiving a plurality of terrestrial radio signals in a broadcast spectrum; providing a communication device for receiving a plurality of internet data signals; providing a user entered preference data; analyzing the user entered preference data; and selectively transmitting the flow content to the user based upon the user entered preference data.

Another method comprises the steps of: providing a terrestrial broadcast radio tuner for receiving a plurality of terrestrial radio signals in a broadcast spectrum; providing a communication device for receiving a plurality of internet data signals; providing a user entered preference data including a manually controlled first slider that is movable to control a variable including one of receiving content from a terrestrial broadcast signal and receiving content from an internet data signal; analyzing the user entered preference data based on a selected indicating position along the slider, wherein the selected position is one of a first position providing all flow content from the terrestrial broadcast signal, a second position providing all flow content from the internet data signal, and at least one intermediate position providing flow content from the terrestrial broadcast signal and the internet data signal; and selectively transmitting the flow content to the user based upon the location of the slider for determining the user entered preference data.

Still another method comprises the steps of: providing a terrestrial radio tuner for receiving a plurality of terrestrial broadcast signals in a broadcast spectrum; providing a communication device for receiving a plurality of internet data signals; providing a user entered preference data including a manually controlled slider that is movable to control a variable including one of receiving content from a terrestrial broadcast signal and receiving content from an internet data signal; selectively indicating points along the slider for specific flow content for one of podcasts, announcements, and updates; analyzing the user entered preference data based on a selected indicating point along the slider; and selectively transmitting the flow content to the user based upon the location of the slider for determining the user entered preference data.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of an adaptive radio system integrated into a vehicle according to an embodiment of the present invention;

FIG. 2 is a schematic block diagram of the radio system of FIG. 1; and

FIG. 3 is a schematic flow diagram of a method for adapting an audio output using multiple signal sources.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

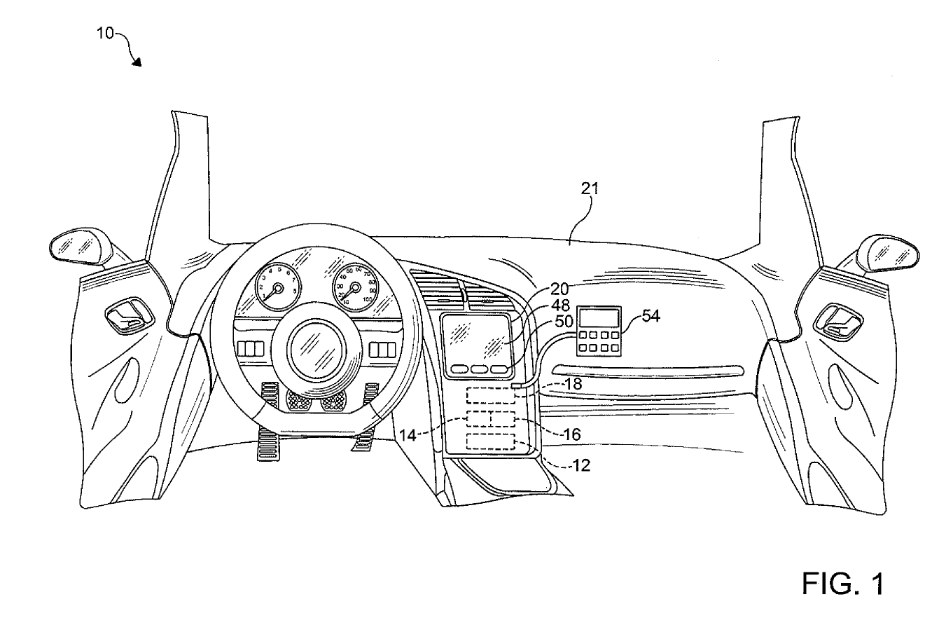

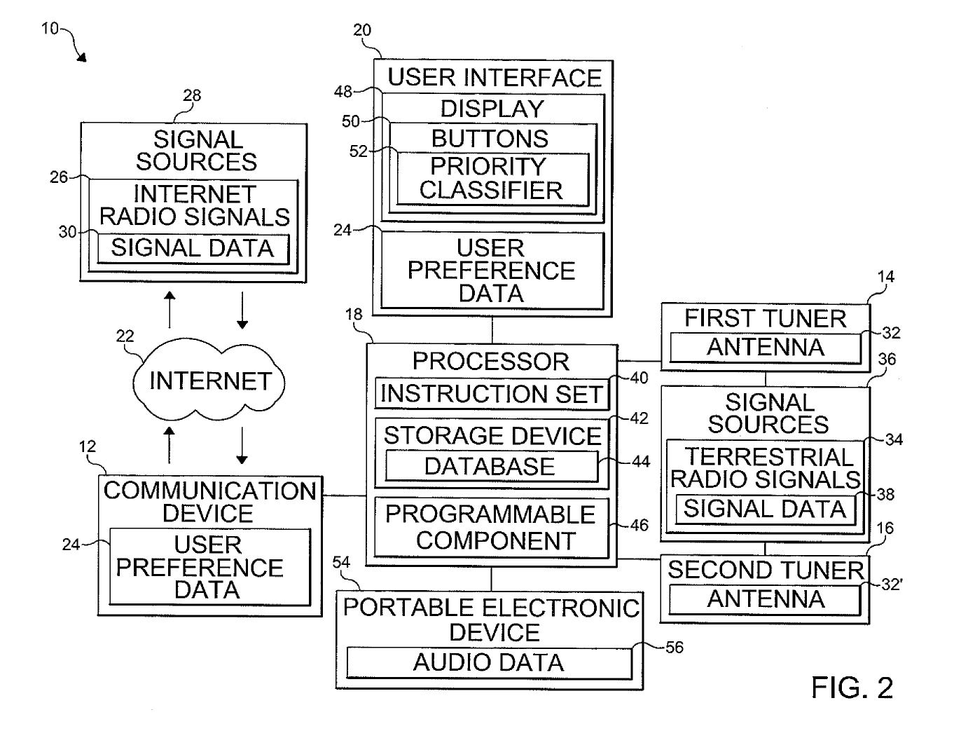

FIGS. 1-2 illustrate an adaptive radio system 10 according to an embodiment of the present invention. As shown, the radio system 10 includes a communication device 12, a first tuner 14, a second tuner 16, a processor 18, and a user interface 20. The radio system 10 can include any number of components, as desired. As a non-limiting example, the radio system 10 is disposed in a vehicle 21. However, the radio system 10 can be integrated in any user environment.

The communication device 12 can be any device, port, or system capable of providing connectivity to the Internet 22. As a non-limiting example, the communication device 12 is a personal electronic device such as a mobile phone, a smart phone, a Wi-Fi™ enabled device, and the like. As a further non-limiting example the communication device 12 is an in-vehicle internet device that is integrated with the vehicle 21, as understood by one skilled in the art.

In certain embodiments, the communication device 12 includes a user preference data 24 representing a plurality of user preferences relating to an audio output (e.g. a genre of music, a news program, a particular musical band, a particular radio channel/station, etc.). Where the user preference data 24 is not stored locally on the communication device 12, the communication device 12 can download the user preference data 24 from a pre-determined location via the Internet 22. As a non-limiting example, the user preference data 24 can be organized as a user profile, wherein any user can create a user profile representing preferences particular to the user. As a further non-limiting example, a secondary software (not shown) can be used to generate a user profile including the user preference data 24 such as the Music Genome Project™ software by Pandora Media, Inc.

In certain embodiments, the communication device 12 is in communication with the Internet 22 to locate and receive a plurality of internet radio signals 26 (i.e. internet data), wherein each of the internet radio signals 26 is hosted/transmitted by one of a plurality of signal sources 28 (e.g. internet radio stations/channels/data sources). As a non-limiting example, each of the internet radio signals 26 received by the communication device 12 includes an internet signal data 30 representing an audio output (e.g. music, talk radio, weather report, etc.). As a further non-limiting example, the internet signal data 30 includes information relating to the signal source 28 of each of the internet radio signals 26, wherein the information includes identification features (i.e. an audio attribute) such as a genre or type of audio output typically broadcast by the associated internet radio channel, a song or artist typically featured on the associated internet radio channel, and the like, for example. It is understood that the internet signal data 30 can include any information to identify and distinguish one of the signal sources 28 from another of the signal sources 28 based upon a typical audio output provided by the associated signal source 28. It is further understood that the internet radio signal 26 can be any data retrieved or transmitted via the Internet 22 or similar communication network now know or later developed.

The first tuner 14 is configured to “tune” to a pre-determined narrow range of frequencies from the total spectrum of broadcast signals and ambient radio waves, as appreciated by one skilled in the art. In certain embodiments, the first tuner 14 is coupled to an antenna 32 to receive a broadcast radio frequency (RF) signal such as a terrestrial radio signal 34 (e.g. HD AM/FM radio or regular AM/FM broadcast) transmitted at a pre-determined frequency by one of a plurality of signal sources 36 (e.g. terrestrial radio frequency channels, radio stations). The antenna 32 may be any device for receiving broadcast signals having a pre-determined range of frequencies.

The terrestrial radio signal 34 includes a terrestrial signal data 38 representing an audio output (e.g. music, talk radio, weather report, etc.). As a further non-limiting example, the terrestrial signal data 38 includes information relating to the signal source 36 of the terrestrial radio signal 34, wherein the information includes identification features (i.e. an audio attribute) such as a genre or type of audio output typically broadcast by the associated terrestrial radio channel, a song or artist typically featured on the associated terrestrial radio channel (i.e. signal source 36), and the like, for example. It is understood that the terrestrial signal data 38 can include any information to identify and distinguish one of the signal sources 36 from another of the signal sources 36 based upon a typical audio output provided by the associated signal source 36.

The second tuner 16 is configured to “tune” to a pre-determined narrow range of frequencies from the total spectrum of broadcast signals and ambient radio waves, as appreciated by one skilled in the art. In certain embodiments, the second tuner 16 is coupled to an antenna 32′ to receive a broadcast radio frequency (RF) signal such as the terrestrial radio signals 34 transmitted at a pre-determined frequency by the signal sources 36. The antenna 32′ may be any device for receiving broadcast signals (e.g. HD AM/FM radio or regular AM/FM broadcast) having a pre-determined range of frequencies.

The processor 18 may be any device or system adapted to receive an input signal, analyze and evaluate the input signal, and control an audio output transmitted to the user based on the analysis of the input signal. In certain embodiments, the processor 18 is a micro-computer. In the embodiment shown, the processor 18 receives the input signal from at least one of the communication device 12 and the user interface 20. As a non-limiting example, the input signal represents at least the user preference data 24. It is understood that the processor 18 may be in communication with and may provide control of other devices (e.g. global positioning system), systems and components.

As shown, the processor 18 analyzes and evaluates the data signal based upon an instruction set 40. The instruction set 40, which may be embodied within any computer readable medium, includes processor executable instructions for configuring the processor 18 to perform a variety of tasks. It is understood that the processor 18 may execute a variety of functions such as controlling the functions of the communication device 12, the first tuner 14, the second tuner 16, and the user interface 20, for example. As a non-limiting example, the instruction set 40 is an algorithm or software adapted to determine the habitual actions and preferences of the user based upon the information received by the processor 18 (e.g. via the user interface 20). Specifically, the processor 18 can generate the user preference data 24 based upon a user-provided input via the user interface 20. As a further example, the instruction set 40 includes an algorithm or software for comparing the user preference data 24 to the signal data 30, 38 of at least one of the internet radio signals 26 and the terrestrial radio signals 34. Accordingly, the instruction set 40 includes processor executable instructions to determine which of the signal data 30, 38 substantially matches the user preference data 24. It is understood that the processor 18 can designate a particular one of the signal sources 28, 36 of at least one of the internet radio signals 26 and the terrestrial radio signals 34 as a “preferred” source/channel or a “matched” source/channel. It is further understood that any number of the signal sources 28, 36 of the internet radio signals 26 and the terrestrial radio signals 34 can be designated as a “preferred” source/channel.

In certain embodiments, the processor 18 includes a storage device 42. The storage device 42 may be a single storage device or may be multiple storage devices. Furthermore, the storage device 42 may be a solid state storage system, a magnetic storage system, an optical storage system, or any other suitable storage system or device. It is understood that the storage device 42 is adapted to store the instruction set 40. Other data and information may be stored and cataloged in the storage device 42 such as the data collected by the user interface 20.

In certain embodiments, the storage device 42 includes a database 44 of the signal sources 28, 36 of the internet radio signals 26 and the terrestrial radio signals 34. As a non-limiting example, the database 44 includes information relating to the signal sources 28, 36 such as a genre or type of audio output typically broadcast by the associated terrestrial radio channel, a song or artist typically featured on the associated terrestrial radio channel, and the like, for example. As a further non-limiting example, the database 44 is updated by a station server (not shown) including a catalog of the signal sources 28, 36, as appreciated by one skilled in the art.

In certain embodiments, the storage device 42 includes a plurality of user profiles (not shown), each of the user profiles including the user preference data 24 associated with a particular user. Accordingly, any one of the user profiles can be selected by the processor 18 to extract the user preference data 24 for analysis and comparison.

In certain embodiments, each time the user interacts with the user interface 20, an entry is created in the storage device 42. The entry includes a plurality of data fields populated with the information received by the user, wherein the entry is analyzed by the processor 18 to define the user preference data 24 for a particular user. For example, every weekday morning between six o′clock and seven o′clock the user tunes the first tuner 14 to a particular preset one of the signal sources 36 (e.g. a favorite morning show). Accordingly, the entry and the user preference data 24 is updated to include the information relating to the particular preset one of the signal sources 36 and the signal data 38 received therefrom.

The processor 18 may further include a programmable component 46. It is understood that the programmable component 46 may be in communication with any other component of the radio system 10 such as the communication device 12, the first tuner 14, the second tuner 16, and the user interface 20, for example. In certain embodiments, the programmable component 46 is adapted to manage and control processing functions of the processor 18. Specifically, the programmable component 46 is adapted to modify the instruction set and control the analysis of the input signals and information received by the processor 18. It is understood that the programmable component 46 may be adapted to manage and control at least one of the communication device 12, the first tuner 14, the second tuner 16, and the user interface 20. It is further understood that the programmable component 46 may be adapted to store data and information on the storage device 42, and retrieve data and information from the storage device 32.

The user interface 20 is in signal communication with at least one of the communication device 12, the first tuner 14, and the second tuner 16 to provide selective control over the at least one of the communication device 12, the first tuner 14, and the second tuner 16. As shown, the user interface 20 is in indirect signal communication with at least one of the communication device 12, the first tuner 14, and the second tuner 16. However, it is understood that the user interface 20 can be in direct signal communication with any component of the system.

The user interface 20 typically includes a display 48 for presenting a visible output to the user. In the embodiment shown, the display 48 is a touch sensitive display (i.e. touch screen) having a plurality of user-engageable buttons 50 presented thereon. In certain embodiments, each of the buttons 50 is associated with an executable function.

As a non-limiting example, the buttons 50 represent a plurality of priority classifiers 52 such as a signal strength, a genre of music, a navigation path, a mood of the user, etc. Accordingly, where a user engages one of the buttons 50 representing a particular priority classifier 52, the processor 18 organizes a list of the “preferred” sources/channels based upon the selected one of the priority classifiers 52. As a non-limiting example, where the priority classifier 52 representing a signal strength is selected by the user, the processor 18 arranges the list of preferred sources based upon a hierarchy of strongest signal strength to weakest signal strength. It is understood that any priority classifier can be used.

As a further non-limiting example, at least one of the buttons 50 represents a “like” feedback and at least one of the buttons 50 represents a “dislike” feedback. Accordingly, when an audio output is transmitted to the user, the user can provide a real-time feedback regarding the audio output. Specifically, where the user engages one of the buttons 50 representing the “like” feedback, the signal data associated with the audio output currently being transmitted to the user is used to update the user preference data 24. It is understood that various techniques for updating the user preference data 24 can be used such as a drag and drop technique using the display 48.

As a further non-limiting example, the user preference data 24 determines the flow content to the user via the user interface 20. The user interface 20 includes a plurality of user-engageable buttons 50. In certain embodiments, the user interface 20 is a human-machine interface (HMI) and includes a user-engageable manually controlled first slider 50. The first slider 50 is provided to control a flow of content to a listener from multiple different sources, including but not limited to: a terrestrial broadcast radio, including AM and FM frequencies; and an Internet data signal.

The first slider 50 is an adjustable control that moves in a linear fashion. The first slider 50 includes a scale extending linearly from a first position at one end of the first slider 50 to a second position at the opposite end of the first slider 50. The first slider 50 is manually controlled. At least one intermediate position is provided between the first position and the second position of the scale, Each position of the scale indicates a percentage of the source of content provided to the user listener. The first position provides one hundred percent (100%) of content to the listener from a terrestrial broadcast radio, while the second position provides one hundred percent (100%) of content to the listener from an Internet data signal. The at least one intermediate position is a one-half (½) position and provides fifty percent (50%) of content to the user listener from a terrestrial broadcast radio and fifty percent (50%) of content to the user listener from an Internet data signal. Multiple intermediate positions provide additional percentages of content to a user listener along a sliding scale, including multiple quarterly positions, such as an intermediate one-quarter (¼) position for providing seventy-five (75%) of content to the user listener from a terrestrial broadcast radio and twenty-five percent (25%) of content to the user listener from an Internet data signal. An additional intermediate three-quarter (¾) position provides twenty-five percent (25%) of content to the user listener from a terrestrial broadcast radio and seventy-five percent (75%) of content to the user listener from an Internet data signal. By way of example, a user listener may set the slider 50 at 75% of content to the user listener from a terrestrial broadcast radio and 25% of content to the user listener from an Internet data signal. On average, whenever the user listener listens to 100 songs, 75 of the songs will come from the terrestrial broadcast radio source and 25 of the songs will come from the Internet data signal source, with no particular ordering or precedent of songs from either source. Alternatively, the user listener may choose to receive this content solely from a terrestrial broadcast radio. The user listener manually adjusts the first slider 50 to the first position and all 100 of the songs are played from the terrestrial broadcast radio. in another example, the user listener may choose to receive this content solely from an Internet data signal. The user listener will manually adjust the first slider 50 to the second position and all 100 of the songs are played from the Internet data signal. Other scales and any indicator of at least one position may be provided along the first slider 50. Additionally, any ratio or percentage of content provided to the listener may be provided along the first slider 50. In another embodiment, the first position of the first slider 50 provides one hundred percent (100%) of content to the user listener from an Internet data signal, while the second position provides one hundred percent (100%) of content to the user listener from a terrestrial broadcast radio. Additionally, pre-set positions are provided along the first slider 50 and may be set by the listener. Further, if additional sources of content are available, including source content from a USB input, a compact disc, or a smart phone, for instance, the first slider 50 provides continuous controls, such as a variable input, to designate a source of content along the scale.

In certain embodiments, a portable electronic device 54 (e.g. digital music player, digital storage device, etc.) is in communication with the processor 18 by a wired (e.g. universal serial bus) or wireless connection. Accordingly, the processor 18 can retrieve an audio data 56 from the portable electronic device for transmission to the user as the audio output. It is understood that any amount of audio data (e.g. two songs) can be retrieved from the portable electronic device 54. It is further understood that the audio data 56 can be retrieved from the portable electronic device 54 and cached in the storage device 42 for subsequent transmission.

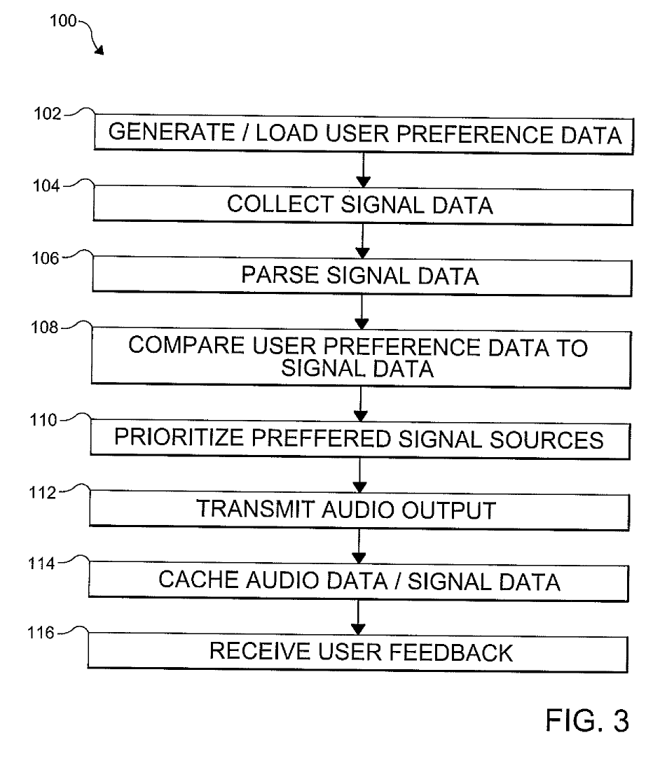

FIG. 3 illustrates a method 100 for adapting an audio output using both terrestrial and internet radio signal sources 28, 36. In step 102, the user preference data 24 is provided (e.g. generated based on a user-provided input, received from a device, downloaded from the Internet 22, retrieved from the storage device 42, etc.).

In step 104, at least one of the first tuner 14 and the second tuner 16 scans a pre-determined spectrum of broadcast signals and receives a plurality of the terrestrial radio signals 34 associated with various signal sources 36. It is understood that one of the tuners 14, 16 can be configured to scan the broadcast spectrum to collect the signal data 38 associated with various ones of the signal sources 36, while the other of the tuners 14, 16 is configured to selectively tune to one of the signal sources 36 to selectively provide an audio output to the user.

Certain ones of the terrestrial radio signals 34 received by at least one of the tuners 14, 16 do not include information relating the audio attributes of the signal source 36. Accordingly, the processor 18 can analyze the terrestrial radio signals 34 to extract information about the audio output and generate information about the signal source 36 of the terrestrial radio signal 34 based upon the audio output, as appreciated by one skilled in the art.

In step 106, the processor 18 receives at least one of the internet radio signals 26 and the terrestrial radio signals 34 including the respective signal data 30, 38. As a non-limiting example, the processor 18 parses the signal data 30, 38 into data fields for subsequent comparison.

In step 108, the processor 18 receives the user preference data 24 from at least one of the communication device 12 and the user interface 20 and analyzes the user preference data 24 based on the instruction set 40. For example, the processor 18 compares the user preference data 24 to the signal data 30, 38 of at least one of the internet radio signals 26 and the terrestrial radio signals 34 to determine which of the signal data 30, 38 substantially matches the user preference data 24. It is understood that the processor 18 can designate a particular signal source 28, 36 as a “preferred” source or channel. It is further understood that any number of the signal sources 28, 36 can be designated as a “preferred” channel.

In step 110, the processor 18 generates a priority list of the “preferred” ones of the signal sources 28, 36 (e.g. terrestrial radio channels and internet radio channels) in response to the comparison executed in step 108. In certain embodiments, the priority list is arranged based upon a signal strength of the preferred ones of the signal sources 28, 36. For example, the processor 18 detects a signal quality of each of the terrestrial radio signals 34 and the internet radio signals 26 and prioritizes the preferred signal sources 28, 36 based upon signal strength.

In certain embodiments, the priority list is arranged based upon genre of music. For example, the user can identify a specific genre or style of music and the processor 18 prioritizes the preferred ones of the signal sources 28, 36 based upon a level of relevance with regard to the specific genre of music identified by the user.

In certain embodiments, the priority list is arranged based upon a navigation route or global position of the vehicle 21. For example, the processor 18 detects a navigation route of the vehicle 21 and prioritizes the preferred ones of the signal sources 28, 36 based upon a position of the vehicle 21 along the navigation route. It is understood that any metric or priority classifier can be used to organize or prioritize the preferred ones of the signal sources 28, 36. It is understood that multiple user preferences, such as mood; genre, artist, and location, for instance, may be considered simultaneously when arranging the priority list.

In step 112, the processor 18 transmits an audio output to the user. As a non-limiting example, the processor 18 selects one of the preferred signal sources 28, 36 as the source of the audio output. As a further non-limiting example, the processor 18 can select any source for the audio output such as the portable electronic device 54, for example.

In step 114, the processor 18 caches a pre-determined amount of data representing an audio output. As a non-limiting example, a digital audio data (e.g. audio data 56) can be stored locally on the storage device 42 for immediate playback as the audio output. As a further non-limiting example, a stream of the signal data 30, 38 can be received and stored locally on the storage device 42 for subsequent playback. Accordingly, the radio system 10 can provide seamless playback of the audio output without interruption during processing or searching for viable signal sources 28, 36.

In step 116, the user can interact with the user interface 20 in order to provide a feedback. As a non-limiting example, the user engages one of the buttons 50 representing a particular one of the priority classifiers 52 to prioritize a list of the “preferred” ones of the signal sources 28, 36. As a further non-limiting example, the user engages one of the buttons 50 representing a “like” feedback. Accordingly, the signal data 30, 38 associated with the audio output currently being transmitted to the user is used to update the user preference data 24.

The radio system 10 according to the present invention selectively transmits an audio output from one of a plurality of sources (e.g. signal sources 28, 36, portable electronic device 54) to a user based upon a preference of the user. Accordingly, the radio system 10 provides a comprehensive solution to preference-based audio playback in various environments including a moving vehicle.

In another method, the user determines the flow content that is transmitted audibly by adjusting the first slider control 50 as described above. When receiving the flow content in step 110, at least one database is created. At least a first database is formed from the terrestrial broadcast radio and at least a second database is formed from the internet data signal. Once the preference data is compared to the signal data in step 108, the audio output selectively transmits from the terrestrial broadcast radio or the Internet data signal, as in step 112. In one embodiment, if the user is listening to an FM broadcast, the system may detect and indicate whether the station provides a corresponding Internet stream in step 110. Detection may be implemented by searching the Internet for the terrestrial radio signal by the call letters of the signal received by a Radio Data System (RDS), a Hybrid Digital radio (HD) signal content, or other audio broadcast radios, such as all digital radio, and a digital audio broadcast (DAB). Alternatively, the system may investigate the station's web page to determine if a stream is provided. The search is performed by investigating the call letters received via RDS, HD, all digital and DAB. Alternatively, given the tuned frequency, the system may use location data to obtain the call letters of the station based on an Internet-based station directory. If no data is provided, the system may use the first database to obtain the station information. Given that information, the system can access the Internet to obtain the call letters of the station based on an Internet-based station directory. If an Internet data signal is available, this information may be added to the first database for future reference.

In another method, the system measures a terrestrial broadcast source associated with an Internet data signal. When receiving the flow content in step 110, at least one database is created. At least a first database is formed from the terrestrial broadcast radio and at least a second database is formed from the Internet data signal. Once the preference data is compared to the signal data in step 108, the audio output selectively transmits from the terrestrial broadcast radio or the Internet data signal, as in step 112. In one embodiment, if the user is listening to an audio output from an Internet data signal, the system determines the associated terrestrial broadcast frequency or call letters, and tunes the tuner 14 to that broadcast to measure the signal strength and quality of the associated radio broadcast. The associated terrestrial broadcast frequency or call letters are obtained from either the first database or from the Internet data signal. The signal strength measurement data is used to determine if the quality of the terrestrial broadcast is sufficient to switch the flow from the Internet data source to the terrestrial broadcast source when the system determines a low audio quality on the Internet data source. The system relies on the search result data to determine if preset criteria of signal strength and quality are met for automatically switching to the corresponding terrestrial broadcast radio station if reception of the Internet data signal is degraded or lost. Alternatively, the system indicates the search result data to the user, providing a HMI readout, allowing the user to manually switch to the corresponding terrestrial broadcast radio station if reception of the Internet data signal is degraded or lost. The signal strength measurement and automatic switching features are implemented by the system regardless of the position of the slider 50. Thus, although the user may have selected a slider position calling for a certain percentage of content from the Internet data source, the user preference input may be overridden by the system automatically, perhaps causing a higher percentage of songs coming from the terrestrial broadcast source then indicated, to provide the user with a better overall listening experience by providing more songs with higher audio quality. In another embodiment, when searching for alternative terrestrial broadcasts, the system may switch to an alternative terrestrial broadcast radio source broadcasting the identical song. The system may switch terrestrial broadcast radio sources if the associated terrestrial broadcast source provides insufficient signal strength to meet the system's preset criteria and an alternative terrestrial broadcast source has sufficient signal strength to meet the system's preset criteria.

In yet another method, when receiving an Internet data signal in step 110, a database may be created, the database formed from the Internet data signal. Further, when receiving a terrestrial radio signal in step 110, a database may be created; the database may be formed from RDS or HD data such as call letters and genre in a non-limiting example. Alternatively, when receiving an Internet data signal in step 110, a database may be created. The Internet data signal database may be augmented with the terrestrial broadcast radio database, forming the user preference flow content. The system may search the database for signal strength quality. In one embodiment, if the user is listening to a radio broadcast that is too weak to receive RDS data or full HD data, the system searches the database to provide the data to the user in step 112. Likewise, if the user is listening to an Internet data signal that is too weak, the system searches the database to provide the data to the user in step 112. The data is provided to the user through a HMI. The HMI indicates the flow content set by the user, indicating a next content and the source of the next content, such as a terrestrial broadcast radio or Internet data signal, or onboard content from a USB input, a compact disc, or a smart phone, for instance. Additionally, the HMI indicates the signal strength quality of the next content. If the signal strength quality of the next content is less than preset criteria of signal strength quality, the system automatically switches to a source having a stronger signal strength quality such as onboard content, where onboard content generally provides better signal strength quality. Alternatively, the system indicates the signal strength quality to the user by providing a HMI readout, allowing the user to choose to manually switch to the corresponding onboard content or continue listening to the user preference flow content. The system automatically switches back to the user preference content flow after the onboard content has played. When the system is switched to the onboard content, the terrestrial broadcast radio and Internet data signal are free to be used by the system for scanning sources of additional content information to add to the database.

As a further non-limiting example, the user interface 20 is a HMI and includes a user-engageable manually controlled second slider 50. The second slider 50 is provided to control a flow of content to a listener through user feedback. In another method, in step 116, the user can interact with the user interface 20 in order to provide a feedback. As a non-limiting example, the user manually locates the second slider control 50 representing a particular one of the priority classifiers 52 to prioritize a list of the “preferred” ones of the signal sources 28, 36. The second slider 50 includes a scale extending linearly from a first position at one end of the scale to a second position at the opposite end of the scale. At least one intermediate position is provided between the first position and the second position of the scale. Each position of the scale indicates a user feedback that is manually controlled by the user. Alternatively, each position may be pre-set by the user. As a further non-limiting example, the user engages a position on the second slider scale 50 representing specific flow content including one of a particular singing artist and similar genre as the particular artist as “like” feedback. Additionally, specific flow content preference may include a user indicating no song to be played by a particular artist and genre not including that of a particular artist as “like” feedback. Other “like” feedback may include the mood of the user or a particular decade of music as non-limiting examples. Accordingly, the signal data 30, 38 associated with the audio output currently being transmitted to the user is used to update the user preference data 24. Additionally, the user may indicate the “like” feedback manually by adjusting the second slider 50 location.

In another embodiment, the second slider 50 is provided to control a flow of content to a listener, such as the next song to be played, the system may search on board content for the same song, and if present, play this song instead of the “next up” song from the broadcast source. Playing the same song from the on board content rather than the broadcast source provides a higher quality of audio content to the user listener. In one method, the system automatically switches back to the broadcast source at the end of the song. While audibly transmitting the alternative broadcast, the system may continue to use and broadcast other content from the source such as graphics content or interrupt for traffic announcements as described below. The system switches to the on board content while the external source is playing the song, and then back to the external source when the song is finished providing the user listener with a more consistent high quality listening experience while maintaining the spontaneity of listing the external content. In another embodiment, the user interface 20 indicates to the user that a switch has occurred and includes a display feature that indicates the current source of the song playing.

In another embodiment, “like” feedback may include a user selectively indicating set points along the second slider control 50 for specific flow content to be a podcast, or current events such as announcement and updates. The “like” feedback includes providing key metadata such as keywords inputted by the user and may include a “more like this” position on the scale of the second slider 50 that searches the Internet data signal and terrestrial radio broadcast using the key words from the podcast currently broadcast to find and play other podcast with the same or similar key words. A “more like this” position may also search the Internet data signal and terrestrial broadcast radio for announcements, such as traffic announcements or news updates. The user may manually select to search for announcements by locating the second slider 50 to a designated position. Alternatively, the “like” feedback may automatically search during preset times. The user may manually select to allow the system to automatically interrupt the normal flow of audio output for announcements such as traffic or news updates at preset times. Alternatively, the interruption may be based on real time detected events.

In certain embodiments, the user interface 20 includes both the first slider and the second slider as the user-engageable buttons 50. The radio system 10 provides the flow of content control to the user through the first slider. The second slider provides additional content control to the using by adapting the user content based on user preferences.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method for determining a flow content transmitted audibly to a user, the method comprising:
providing a terrestrial radio tuner for receiving a plurality of terrestrial radio signals in a broadcast spectrum;
providing a communication device for receiving a plurality of internet data signals;
providing a user entered preference data;
analyzing the user entered preference data; and
selectively transmitting the flow content to the user based upon the user entered preference data.

2. The method according to claim 1, wherein the user entered preference data comprises an adjustable control first slider including a scale extending linearly from a first position at one end of the first slider to a second position at the opposite end of the first slider.

3. The method according to claim 2, wherein locating the slider at one end exclusively receives terrestrial broadcast radio signals.

4. The method according to claim 2, wherein locating the slider at the opposite end exclusively receives an internet data signal.

5. The method according to claim 2, wherein locating the slider between the first end and the opposite end receives both terrestrial broadcast radio signals and Internet data signal, wherein the flow content to the user is a percentage of songs from the terrestrial broadcast radio and internet data signal based on the location of the slider relative to each end.

6. The method according to claim 3, further comprising the steps of, when listening to the terrestrial broadcast radio signal,
detecting a corresponding internet data signal by searching the internet for the terrestrial broadcast signal by call letters of a signal received by one of a radio data system, a hybrid digital radio, an all digital radio, a digital audio broadcast, and an internet based station directory;
using the information detected to automatically switch to the corresponding internet data signal; and
transmitting the internet data signal audio to the user.

7. The method according to claim 6, further comprising the step of automatically switching back to the terrestrial broadcast signal received prior to automatically switching to a stronger measured signal.

8. The method according to claim 1, further comprising the steps of, when listening to the internet data signal,
measuring at least one of a signal strength and a quality of the terrestrial broadcast signal;
comparing the measurement to a preset criteria; and
using the information measured to automatically switch from the signal having less than the preset criteria; and
transmitting the stronger signal audio to the user.

9. The method according to claim 6, further comprising, the step of automatically switching back to the Internet data signal received prior to automatically switching to the stronger measured signal.

10. The method according to claim 5, further comprising the step of, when receiving the internet data signal,
creating a database formed from the internet data signal.

11. The method according to claim 10, further comprising the steps of, when receiving the terrestrial broadcast signal,
creating a database formed from at least one of a radio data system, a hybrid digital radio, an all digital radio, and a digital audio broadcast;
augmenting the database formed from the internet data signal with the database formed from at least one of the radio data system, a hybrid digital radio, an all digital radio, a digital audio broadcast, and an internet based station directory;
measuring at least one of a signal strength and a quality of the broadcast;
comparing the measurement to a preset criteria; and
using the information measured to automatically switch from the signal having less than the preset criteria; and
transmitting the stronger signal audio to the user.

12. The method according to claim 11, further comprising the step of automatically switching back to the terrestrial broadcast signal received prior to automatically switching to the stronger signal.

13. The method according to claim 10, further comprising the step of, if the measured signal strength and quality does not meet the preset criteria,
automatically switching to onboard content; and
using at least one of the terrestrial broadcast radio and the internet data signal for scanning sources of additional content information to add to the database.

14. A method for determining a flow content transmitted audibly to a user, the method comprising:
providing a terrestrial broadcast radio tuner for receiving a plurality of terrestrial radio signals in a broadcast spectrum;
providing a communication device for receiving a plurality of internet data signals;
providing a user entered preference data including a manually controlled first slider that is movable to control a variable including one of receiving content from a terrestrial broadcast signal and receiving content from an internet data signal;
analyzing the user entered preference data based on a selected indicating position along the slider, wherein the selected position is one of a first position providing all flow content from the terrestrial broadcast signal, a second position providing all flow content from the Internet data signal, and at least one intermediate position providing flow content from the terrestrial broadcast signal and the internet data signal; and
selectively transmitting the flow content to the user based upon the location of the slider for determining the user entered preference data.

15. The method of claim 14, further comprising the step of providing a second slider control comprised of a scale laterally extending along the slider control, the scale having positions for simultaneously selecting specific flow content including one of a particular singing artist, a similar genre to the particular singing artist, a same genre as the particular singing artist, no song played by a particular singing artist, and a genre not including that of a particular singing artist, mood, and decade.

16. The method of claim 14, wherein the flow content to be transmitted audibly to the user may be selected at any time during transmission.

17. A method for determining a flow content transmitted audibly to a user, the method comprising:
providing a terrestrial radio tuner for receiving a plurality of terrestrial broadcast signals in a broadcast spectrum;
providing a communication device for receiving a plurality of internet data signals;
providing a user entered preference data including a manually controlled slider that is movable to control a variable including one of receiving content from a terrestrial broadcast signal and receiving content from an internet data signal;
selectively indicating points along the slider for specific flow content for one of podcasts, announcements, and updates;
analyzing the user entered preference data based on a selected indicating point along the slider; and
selectively transmitting the flow content to the user based upon the location of the slider for determining the user entered preference data.

18. The method of claim 17, wherein the flow content to be transmitted audibly to a user includes podcasts based on metadata associated with the podcasts and further comprises the step of:
while transmitting a selected podcast, manually inputting search words; and
searching for similar podcasts based on same or similar metadata.

19. The method of claim 18, wherein the flow content to be transmitted audibly to a user includes podcasts based on search results of the metadata associated with the podcasts and further comprises the step of:
playing similar podcasts based on same or similar metadata.

20. The method of claim 17, wherein the flow content to be transmitted audibly to a user includes announcements and updates and further comprises the step of:
interrupting the flow content with real time detected events including traffic and emergency alerts.
